(19) United States
(12) Patent Application Publication
(10) Pub. No.: US 2015/0280522 A1
(43) Pub. Date: Oct. 1, 2015

(54) ELECTRIC MACHINE HAVING ROTOR COOLING ASSEMBLY

(71) Applicant: Caterpillar Inc., Peoria, IL (US)

(72) Inventors: Gregory Thomas AUSTIN, East Peoria, IL (US); Jonathan Mathew BAUMANN, Peoria, IL (US); Thomas Lee NAHRWOLD, Dunlap, IL (US); Joseph Daniel TIGUE, Peoria, IL (US); Timothy James SCHLACK, Washington, IL (US); Vance Michael BUATTE, Danvers, IL (US)

(73) Assignee: Caterpillar Inc., Peoria, IL (US)

(21) Appl. No.: 14/230,830

(22) Filed: Mar. 31, 2014

(51) Int. Cl. H02K 9/19

(52) U.S. Cl. CPC H02K 9/19

(57) ABSTRACT

A cooling assembly is disclosed for use with an electric machine having bearings, a shaft rotatably supported by the bearings, a rotor connected to the shaft, and a stator annularly surrounding the rotor. The cooling assembly may have an end cap configured to engage an end of the rotor and the shaft to thereby axially locate the rotor relative to the shaft. The end cap may include an annular groove formed therein to receive a flow of cooling oil. The cooling assembly may further have an annular baffle axially connected to an end of the end cap and extending radially inward at least partially across an opening of the annular groove, and a slinger axially connected to the annular baffle opposite the end cap. The slinger may include a recess formed therein that is configured to trap the cooling oil after it flows through the annular baffle.

### TECHNICAL FIELD

The present disclosure relates generally to an electric machine and, more particularly, to an electric machine having a rotor cooling assembly.

### BACKGROUND

Electric machines, such as motors and generators, are used to generate mechanical power in response to an electrical input or to generate electrical power in response to a mechanical input. Magnetic, resistive, and mechanical losses within the motors and generators during mechanical and electrical power generation cause a build up of heat, which is dissipated to avoid malfunction and/or failure of the electric machine. One of the limitations on the power output of an electric machine is the capacity of the electric machine to dissipate this heat.

One exemplary arrangement for dissipating heat within an electric machine is disclosed in U.S. Patent Application No. 2011/0084561 of Swales et al. that published on Apr. 14, 2011 (“the '561 publication”). Specifically, the '561 publication discloses an oil-cooled motor/generator for an automotive powertrain. The motor/generator, includes a stator, a rotor circumscribed by the stator, a motor shaft on which the rotor is mounted, a housing assembly that surrounds the stator and rotor, and bearings positioned between the housing assembly and the motor shaft at opposing ends of the rotor. A rotor end ring is located axially adjacent the rotor and around the motor shaft at each end, and a dam member is either integrally formed with each rotor or separately attached to each rotor. The dam member extends axially outward and radially inward to temporarily trap and distribute cooling oil flow circumferentially around the rotor end rings, before centrifugal forces cause the cooling oil to spill outward over the dam member.

Although the arrangement of the '561 publication may improve cooling by temporarily trapping oil at the rotor end rings, the arrangement may be less than optimal. In particular, the arrangement may provide inconsistent oil coverage in some applications as a result of how the oil is introduced into the dam member of the end ring. Specifically, the entering oil may disrupt the spilling of oil over the dam member at the entrance location, leaving a gap in stator oil coverage. This could result in improper cooling of a wound stator motor.

The disclosed cooling assembly is directed to overcoming one or more of the problems set forth above.

### SUMMARY

In one aspect, the present disclosure is directed to an end cap for a rotor. The end cap may include a ring-shaped body having an inner axial surface that is generally planar and configured to engage the rotor, and an outer axial surface that is located opposite the inner axial surface. The end cap may also include an annular groove formed within the outer axial surface, the annular groove having an inner radial side surface with concave curvature.

In another aspect, the present disclosure is directed to a cooling assembly for use with an electric machine having bearings, a shaft rotatably supported by the bearings, a rotor connected to the shaft, and a stator annularly surrounding the rotor. The cooling assembly may include an end cap configured to engage an end of the rotor and the shaft to thereby axially locate the rotor relative to the shaft. The end cap may have an annular groove formed therein to receive a flow of cooling oil. The cooling assembly may further include an annular baffle axially connected to an end of the end cap and extending radially inward at least partially across an opening of the annular groove, and a slinger axially connected to the annular baffle opposite the end cap. The slinger may form a recess that is configured to trap the cooling oil after it flows through the annular baffle.

In yet another aspect, the present disclosure is directed to a method of cooling an electric machine. The method may include directing cooling oil axially into an annular groove in a rotor end cap, and directing the cooling oil to circulate radially outward within the annular groove. The method may also include directing the cooling oil axially out of the annular groove and into a radial channel, and allowing the cooling oil to move radially inward and spill over a lip at an axial end of the radial channel.

### BRIEF DESCRIPTION OF THE DRAWINGS

FIG. 1 is a cross-sectional illustration of an exemplary disclosed electric machine; and

FIG. 2 is a cross-sectional illustration of a cooling assembly of the electric machine of FIG. 1.

### DETAILED DESCRIPTION

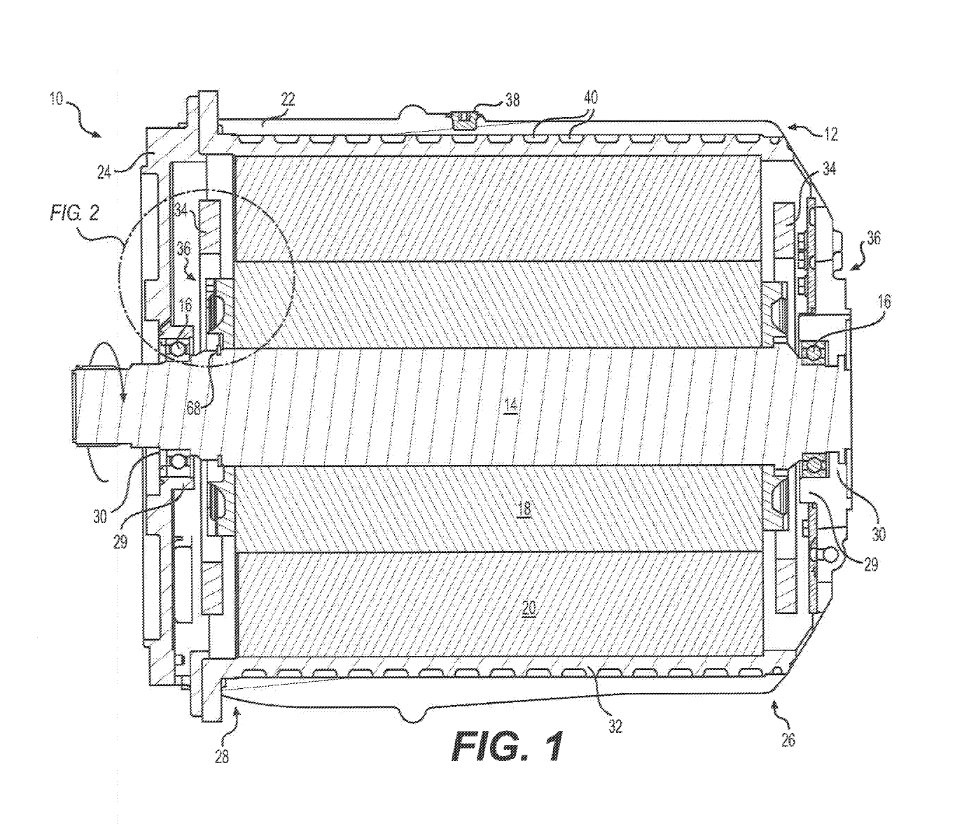

FIG. 1 illustrates an exemplary electric machine 10. Electric machine 10 may be a generator or a motor, or selectively function as both a generator and a motor. For example, electric machine 10 may be driven (e.g., by an engine) to produce electricity, such as in a hybrid vehicular application or a stationary power generation application. Alternatively, electric machine 10 may be powered with electricity to produce a mechanical rotation, such as in an engine starting application or an electric winching application. Or, electric machine 10 could function in some instances as a generator and in other instances as a motor, such as in an electric powertrain propelling and braking application,

Regardless of the application, electric machine 10 may include, among other things, a housing 12, a shaft 14 rotatably supported within housing 12 at opposing ends by bearings 16, a rotor 18 operatively coupled to rotate with shaft 14, and a fixed stator 20 that annularly surrounds rotor 18. When shaft 14 and rotor 18 are mechanically driven to rotate within housing 12 and bearings 16, an associated rotating magnetic field may produce an electric current within stator 20. Likewise, when an electric current is passed through stator 20, a magnetic field may be generated that causes rotor 18 and shaft 14 to rotate. It is contemplated that electric machine 10 may contain additional or different components such as, for example, a control system, a processor, power electronics, one or more sensors, a power storage device, and/or other components known in the art.

Housing 12 may generally consist of two parts, including a shell 22 and an end cover 24. Shell 22 may be tubular, having a closed first end 26 and an open second end 28. Shell 22 may substantially enclose shaft 14, bearings 16, rotor 18, and stator 20, and end cover 24 may be configured to engage and close off second end 28 of shell 22. It is contemplated that, in some embodiments, shell 22 may have two open ends, instead of one open end and one closed end, and two end covers that close off the open ends, if desired. Shell 22, at first end 26, and end cover 24, at second end 28, may each include a collar 29 that protrudes axially inward to provide mounting for bearings 16, and a centrally located through-hole 30 that allows the extension of shaft 14 through the opposing ends of housing 12, It is contemplated that shaft 14 may alternatively protrude through only end cover 24 or through only first end 26 of shell 22, if desired.

Rotor 18 may be fixedly connected to shaft 14 to interact with a magnetic field within electric machine 10 in response to a rotation of shaft 14. In one embodiment, rotor 18 includes multiple radially protruding portions also known as rotor teeth. As each protruding portion is rotated to interact with the magnetic field of stator 20, a corresponding current may be produced.

Stator 20 may be fixed to housing 12 to produce the magnetic field that interacts with the radially protruding portions of the steel laminations. Like rotor 18, stator 20 may also include laminations of steel formed into teeth. The teeth of stator 20 may protrude radially inward toward the outwardly protruding rotor teeth described above. In some applications, stator 20 may also include an iron sleeve 32 surrounding the ring of laminations, and windings 34 of copper wire attached to each stator tooth to form a plurality of poles. As rotor 18 is rotated to interact with the magnetic field of stator 20, electrical current may be sequentially generated from windings 34 through each of the plurality of poles.

As also illustrated in FIG. 1, electric machine 10 may include an internal cooling assembly 36 configured to direct a cooling oil throughout or near the primary heat-generating components of electric machine 10. In one example, the oil may enter housing 12 via a distribution port 38, and flow first through annular grooves 40 around sleeve 32. After passing through annular grooves 40, the oil may be directed to both cooling assemblies 36 located at the opposing ends of housing 12 via one or more internal passages (not shown), where the oil may function to cool the opposing ends of rotor 18 and windings 34 of stator 20. Alternatively, the cooling oil may be provided with a direct path from an external supply to the opposing ends of housing 12 (e.g., by way of an external rail—not shown), without first passing through sleeve 32, In this latter embodiment, a separate flow of cooling oil may be directed through annular grooves 40, if desired, or annular grooves 40 may be omitted.

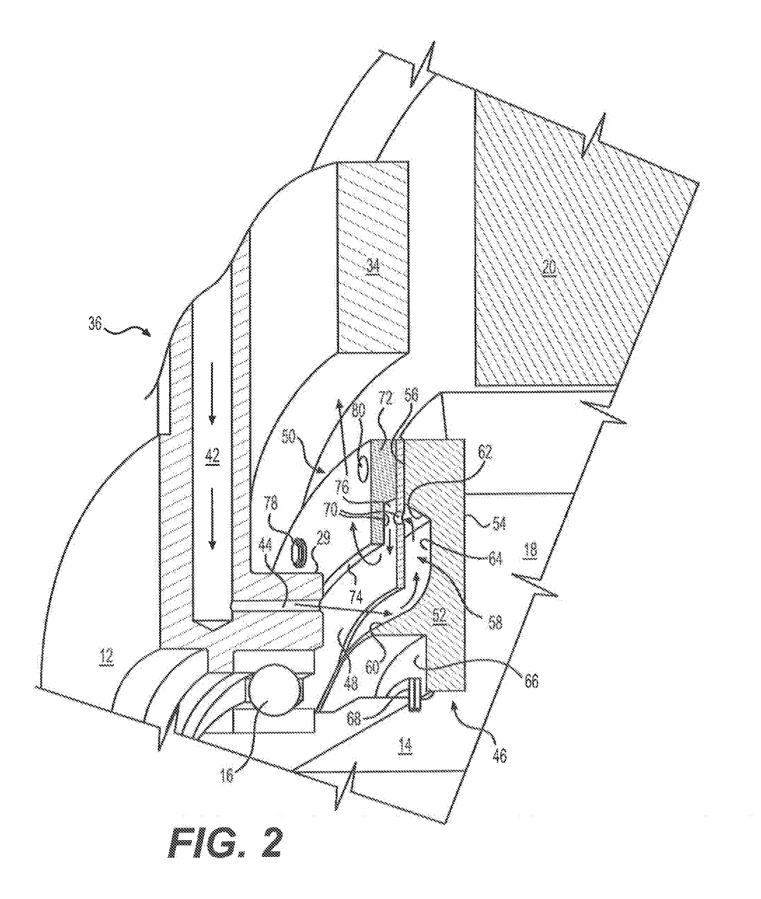

As shown in the enlarged image of FIG. 2, each cooling assembly 36 may include, among other things, a radial flow passage 42 formed within housing 12 (e.g., formed with the axial end wall of housing 12 at first end 26 and formed at second end 28 within end cover 24), an axial flow passage 44 formed within collar 29 that intersects with radial flow passage 42, a rotor end cap 46, a baffle 48, and a slinger 50. Radial flow passage 42 may be configured to pass pressurized cooling oil radially inward from annular grooves 40 of sleeve 32 (or alternatively from a dedicated external rail) to axial flow passage 44. Axial flow passage 44 may then redirect the cooling oil axially inward through collar 29 and past bearings 16 into rotor end cap 46. The cooling oil may circulate within rotor end cap 46, and then flow in a reverse outward axial direction past (e.g., through or around) baffle 48 and against slinger 50 (e.g., into channel formed at least partially by slinger 50). From slinger 50, the cooling oil may spill over a lip of slinger 50 and be slung via centrifugal forces radially outward against windings 34. The cooling oil may then exit electric machine 10 in any manner known in the art (e.g., by way of a sump, one or more discharge ports, and/or a termination box), and be directed to a heat exchanger (not shown). Within the heat exchanger, the previously absorbed heat can be transferred to the atmosphere before returning back to electric machine 10.

As shown in FIG. 2, rotor end cap 46 may include a ring-shaped body 52 having an inner axial surface 54 and an outer axial surface 56. Inner axial surface 54 may be generally planar and configured to engage an end of rotor 18 (i.e., an end of the stack of steel laminations of rotor 18). Outer axial surface 56 may likewise be generally planar, and located at an end opposite inner axial surface 54.

An annular groove 58 may be formed within outer axial surface 56. Groove 58 may have an inner radial surface 60, an outer radial surface 62, and a flat axial bottom 64. Groove 58 may have an asymmetric cross-section, wherein inner radial surface 60 has concave curvature and becomes tangent at an interior edge with bottom 64 and outer radial surface 62 is generally planar and tilted axially outward. It is contemplated that inner radial surface 60 could alternatively be generally planar (e.g., tilted relative to a central axis) and curved only at the interior edge thereof to tangentially intersect bottom 64, if desired.

The geometry of groove 58 may promote circulation of cooling oil without causing significant splashing. In particular, the fluid flow discharged from axial passage 44 may spray directly onto the concavity of inner radial surface 60, and follow the gentle curvature of this surface axially inward and radially outward across bottom 64. The concave shape of inner radial surface 60 may cause little, if any, rebound or deflection in the incoming oil spray, allowing a majority of the incoming oil to create a substantially uniform volume or head within groove 58.

A plate-like annular flange 66 may be formed inward of groove 58 and used to axially locate end cap 46 and rotor 18 relative to shaft 14. Specifically, a snap ring 68 or other similar fastener may be configured to engage shaft 14 (e.g., engage an annular channel in shaft 14) and abut flange 66 (see second end 28 in FIG. 1). Alternatively, annular flange 66 may itself be configured to directly abut a shoulder of shaft 14 (see first end 26 in FIG. 1).

As also shown in FIG. 2, baffle 48 may function as a temporary intermediate dam and also as a diffuser for the cooling oil trapped within groove 58 of rotor end cap 46. Specifically, baffle 48 may be ring-shaped and generally plate-like, extending radially inward over a majority of groove 58. This radial extension may create a radial depth within groove 58 that allows a large amount of cooling oil to be trapped therein. And as groove 58 fills with oil, one or more discharge ports 70 (e.g., through holes) strategically placed around baffle 48 may allow the trapped oil to leak into slinger 50. In the disclosed embodiment, baffle 48 includes two discharge ports 70 at each of two locations on diametrically opposing sides of baffle 48. That is, baffle 48 may include a total of four discharge ports 70, including two spaced apart pairs of two ports 70. With this configuration, the flow of incoming oil may pass primarily from groove 58 through discharge ports 70, and not over an inner radial lip of baffle 48. And, although the oil may be sprayed from only a single stationary location (i.e., from only axial flow passage 44) into the rotating end cap 46, the oil may subsequently be distributed from groove 58 through discharge ports 70 substantially evenly into slinger 50. It is contemplated that baffle 48 could have a different number of discharge ports 70 and/or that discharge ports 70 could be positioned at other locations within baffle 48, if desired. it is also contemplated that discharge ports could be formed to pass the oil around an outer radial periphery of baffle 48 instead of through baffle 48, if desired.

Like baffle 48, slinger 50 may also function as a temporary dam for the cooling oil. Specifically, slinger 50 may include a ring-like base 72, and an annular flange 74 that extends radially inward from base 72. Flange 74 may have a thickness that is less than a thickness of base 72, such that when base 72 is assembled against baffle 48, a space or channel 76 is formed between baffle 48 and flange 74 that is configured to hold a temporary supply of cooling oil received via discharge ports 70. Flange 74 may extend inward a radial distance less than an extension distance of baffle 48, such that channel 76 is not as radially deep as groove 58. In addition, an axial width of channel 76 may be less than an axial width of groove 58. As channel 76 becomes full of Cooling oil, the oil may spill inwardly over an inner lip of flange 74 and then be flung radially outward through the rotation of slinger 50 toward windings 34.

Slinger 50, baffle 48, and end cap 46 may all be held together via a plurality of fasteners 78. Specifically, each of rotor 18, end cap 46, baffle 48, and slinger 50 may include holes 80 that are aligned with each other and configured to receive fasteners 78. The holes 80 in end cap 46 may be threaded to engage corresponding threads of fasteners 78, while the holes 80 in baffle 48 and slinger 50 may be clearance holes.

It is contemplated that any two or more of end cap 46, baffle 48, and slinger 50 could alternatively be fabricated as an integral component, if desired. For example, slinger 50 could be integral with body 52, and baffle 48 could be a ring (e.g., a snap ring) that is retained within a radial groove of the resulting integral component (i.e., as opposed to being bolted between slinger 50 and end cap 46), In this embodiment, holes 80 may not pass through baffle 48. Instead, holes 80 may be formed within the single integral component of end cap 46 and slinger 50 (e.g., at locations radially outward of the snap ring baffle 48), such that the oil passes around the outside of baffle 48 instead of through baffle 48.

In yet another embodiment, baffle 48 and slinger 50 could both be rings that are retained within radial grooves of end cap 46. In other words, end cap 46 may have an annular protrusion that extends axially outward past an outer periphery of baffle 48 and slinger 50, with the radial grooves being formed within the annular protrusion.

In another embodiment, only baffle 48 may be integrally formed with end cap 46. In this example, body 52 of end cap 46 may include an inner annulus spaced apart from an outer annulus, with radially extending ribs connecting the inner and outer annuluses. In this design, baffle 48 may extend inward from the outer annulas to cover at least some of the space between the inner and outer annuluses. The oil may be directed, in this design, against curved inner radial surface 60 of the inner annulas, against an exposed end of rotor 18, and flow axially back out through holes 72 in baffle 48.

It is also contemplated that baffle 48 could have a shape other than plate-like, if desired. For example, baffle 48 could have an L-shaped cross-section. That is, baffle 48 could protrude axially outward at an inner periphery (i.e., baffle 48 could form a collar around shaft 14). In another example, baffle 48 could tilt inward toward rotor 18 and/or have a dished shape, if desired. Either Of these designs may result in greater capture of splashing oil.

### INDUSTRIAL APPLICABILITY

The disclosed electric machine finds potential application in any power system where it is desirable to dissipate substantial amounts of heat in a controlled and uniform manner. The disclosed electric machine finds particular applicability in vehicle drive systems. However, one skilled in the art will recognize that the disclosed electric machine could be utilized in relation to other drive systems that may or may not be associated with a vehicle. The heat-transferring operation of electric machine 10 will now be described.

Referring to FIG. 1, as the flow of the cooling oil enters electric machine 10, it may be directed radially inward through port 38 and then annularly around stator 20 via grooves 40 in sleeve 32. This same flow (or a different and dedicated flow of oil) may then be directed radially inward at both ends of electric machine 10. Specifically, the oil may be directed inward through the axial wall of housing 12 at first end 26 and inward through end cover 24 at second end 28 via radially passages 42. (referring to FIG. 2). The oil may then be redirected through about 90° to flow axially inward through axial passages 44 and be sprayed past slingers 50 and past baffles 48 into grooves 58 of end caps 46.

After entering grooves 58, the oil may follow the concave curvature of inner radial surfaces 60, flow radially outward across bottoms 64, and be redirected axially outward against baffle 48. The oil may fill grooves 58 and circulate annularly around end caps 46 until discharge ports 70 in baffles 48 are reached, The oil may then be discharged axially outward from grooves 58 into channels 76 formed by flanges 74 of slingers 50. The oil being discharged from ports 70 may fill channels 76 and then begin to spill inward over the lips of flanges 74. From this location, the oil may be slung radially outward toward windings 34 of stator 20.

Greater cooling efficiency of electric machine 10 may be realized because the heat-transferring oil is directed evenly to components within electric machine 10 that tend to generate the greatest amount of heat. Specifically, because the oil is allowed to remove heat from windings 34 at the ends of stator 20 (as well as from an annular periphery of stator 20, in some embodiments), a significant amount of heat may be absorbed. And because the heat-transferring oil may transfer heat evenly with electric machine 10 (Le., from both bearings 16 and both ends of rotor 18 and stator 20), any heat-induced stresses experienced by the components of electric machine 10 may be reduced. Additional advantages may be realized because the fluid passageways of electric machine 10 direct the cooling oil to the ends and also around the periphery of stator 20. In particular, transferring heat with both the ends and the outer surfaces of stator 20 may increase the transfer capacity of electric motor 10.

It will be apparent to those skilled in the art that various modifications and variations can be made to the electric machine of the present disclosure. Other embodiments of the electric machine will be apparent to those skilled in the art from consideration of the specification and practice of the electric machine disclosed herein. it is intended that the specification and examples be considered as exemplary only, with a true scope of the disclosure being indicated by the following claims and their equivalents.

What is claimed is:

1. An end cap for a rotor, comprising:
a ring-shaped body having an inner axial surface that is generally planar and configured to engage the rotor, and an outer axial surface that is located opposite the inner axial surface; and
an annular groove formed within the outer axial surface, the annular groove having an inner radial side surface with concave curvature.

2. The end cap of claim I, wherein a cross-section of the annular groove is asymmetrical.

3. The end cap of claim 1, wherein the annular groove further includes an outer radial side surface that is generally planar and tilted axially outward.

4. The end cap of claim I, wherein the annular groove has a flat axial bottom, and the inner radial side surface is tangential with the flat axial bottom.

5. The end cap of claim I, further including an inner annular flange configured to engage a shaft and thereby axially locate the rotor relative to the shaft.

6. A cooling assembly for an electric machine having bearings, a shaft rotatably supported by the bearings, a rotor connected to the shaft, and a stator annularly surrounding the rotor, the cooling assembly comprising:
an end cap configured to engage an end of the rotor and the shaft to thereby axially locate the rotor relative to the shaft, the end cap having an annular groove formed therein to receive a flow of cooling oil;
an annular baffle axially connected to an end of the end cap and extending radially inward at least partially across an opening of the annular groove; and
a slinger axially connected to the annular baffle opposite the end cap, the slinger forming a channel that is configured to trap cooling oil after it flows past the annular baffle.

7. The cooling assembly of claim 6, wherein the annular baffle includes at least one axial hole configured to allow passage of the cooling oil from the annular groove of the end cap into the channel of the slinger.

8. The cooling assembly of claim 7, wherein the at least one axial hole includes at least two axial holes located at diametrically opposing sides of the annular baffle.

9. The cooling assembly of claim 8, wherein the at least two holes includes two pairs of two holes, each pair of two holes being located at diametrically opposing sides of the annular baffle.

10. The cooling assembly of claim 6, wherein the annular baffle extends radially inward a greater distance than the slinger.

11. The cooling assembly of claim 6, wherein the channel has an axial depth that is less than an axial depth of the annular groove in the end cap.

12. The cooling assembly of claim 6, wherein:
the end cap, the annular baffle, and the slinger each includes a plurality of holes located around a. periphery; and
the cooling assembly further includes a plurality of fasteners configured to pass through the plurality of holes and clamp the slinger, the annular baffle, and the end cap to each other.

13. The cooling assembly of claim 6, further including:
a housing configured to secure the bearings; and
a cooling passage formed within walls of the housing and configured to direct the flow of cooling oil axially into the annular groove, past the slinger and the annular baffle.

14. The cooling assembly of claim 13, wherein the cooling passage includes an axial portion formed radially outward of the bearings.

15. The cooling assembly of claim 14, wherein the cooling passage further includes a radial portion passing through an axial end wall of the housing to supply cooling oil to the axial portion at the bearings.

16. The cooling assembly of claim 13, wherein:
the end cap is a first end cap configured to engage a first end of the rotor and the shaft;
the annular baffle is a first annular baffle connected to an end of the first end cap;
the slinger is a first slinger axially connected to the first annular baffle;
cooling passage is a first cooling passage; and
the cooling assembly further includes:
a second end cap configured to engage a second end of the rotor and the shaft, and having a second annular groove;
a second annular baffle connected to an end of the second end cap;
a second slinger axially connected to the second annular baffle; and
a second cooling passage formed within the walls of the housing and configured to direct the flow of cooling oil axially into the second annular groove, past the second slinger and the second annular baffle.

17. A method of cooling an electric machine, comprising:
directing cooling oil axially into an annular groove in a rotor end cap;
directing the cooling oil to circulate radially outward within the annular groove;
directing the cooling oil axially out of the annular groove and into a radial channel; and
allowing the cooling oil to move radially inward and spill over a lip at an axial end of the radial channel.

18. The method of claim 17, wherein directing the cooling oil axially into the annular groove includes directing the cooling oil against a concave radially inner surface of the annular groove at a single location.

19. The method of claim 19, wherein directing the cooling oil axially out of the annular groove includes directing the cooling oil through a hole in an annular baffle.

20. The method of claim 19, wherein directing the cooling oil axially out of the annular groove includes directing the cooling oil into the radial channel from multiple locations around the annular groove.
